(19) United States
(12) Patent Application Publication
(10) Pub. No.: US 2015/0036600 A1
(43) Pub. Date: Feb. 5, 2015

(54) APPARATUS AND METHOD FOR RETRANSMITTING HYBRID AUTOMATIC REPEAT REQUEST (HARQ)

(71) Applicant: Electronics and Telecommunications Research Institute, Daejeon (KR)

(72) Inventor: Tae Chul HONG, Daejeon (KR)

(21) Appl. No.: 14/301,530

(22) Filed: Jun. 11, 2014

(30) Foreign Application Priority Data
Aug. 2, 2013 (KR) 10-2013-0091858
Oct. 4, 2013 (KR) 10-2013-0118822

(51) Int. Cl. H04L 1/18

(52) U.S. Cl. CPC H04L 1/1812
USPC 370/329

(57) ABSTRACT

An apparatus and method for packet transmission that may retransmit a hybrid automatic repeat request (HARQ), receive a plurality of feedbacks in response to transmissions of a plurality of packets for retransmission, and retransmit, using a second component carrier, a packet transmitted using a first component carrier when a negative acknowledgement (NACK) feedback with respect to the first component carrier is received and an acknowledgment (ACK) feedback with respect to the second component carrier is received.

### CROSS-REFERENCE TO RELATED APPLICATIONS

This application claims the benefit of Korean Patent Application No. 10-2013-0091858, filed on Aug. 2, 2013, and Korean Patent Application No. 10-2013-0118822, filed on Oct. 4, 2013, in the Korean Intellectual Property Office, the disclosures of which are incorporated herein by reference.

### BACKGROUND

1. Field of the Invention

The present invention relates to packet transmission technology, and more particularly, to an apparatus and method for retransmitting a hybrid automatic repeat request (HARQ).

2. Description of the Related Art

In the field of radio communication systems, continuous attempts to increase a transmission capacity by extending a bandwidth used in a system are ongoing.

A long term evolution-advanced (LTE-A) system developed from a third generation partnership project long term evolution (3GPP LTE) Rel-8 system adopts component carrier aggregation technology for bandwidth extension. The LTE-A system may combine five 20 megahertz (MHz) bandwidths, thereby supporting a total of 100 MHz bandwidth.

In contrast to an LTE system using a single component carrier, the LTE-A system may need a separate entity to process a hybrid automatic repeat request (HARQ) for each component carrier. An upper layer may need to operate, irrespective of component carrier aggregation used at a lower layer.

The LTE-A system may need to resolve an issue of a transmission performance changed based on a component carrier used for packet transmission. Rather, the transmission performance may be changed based on an interference environment. In particular, a signal to interference plus noise ratio (SINR) may vary in different interference environments. A different SINR for each component carrier may restrict a modulation coding scheme (MCS) to be used for the component carrier.

### SUMMARY

An aspect of the present invention provides an apparatus and method for transmitting a packet.

Another aspect of the present invention also provides an apparatus and method for retransmitting a hybrid automatic repeat request (HARQ).

According to an aspect of the present invention, there is provided a method of retransmitting an HARQ in a component carrier aggregation communication apparatus for transmitting a packet, the method including transmitting a plurality of packets using a plurality of component carriers, respectively, receiving a plurality of feedbacks in response to the transmitting through the plurality of component carriers, and retransmitting, using a second component carrier, a first packet transmitted using a first component carrier, among the plurality of packets, when a negative acknowledgement (NACK) feedback with respect to the first component carrier is received and an acknowledgment (ACK) feedback with respect to the second component carrier is received, among the plurality of component carriers.

The plurality of packets may correspond to a radio link control (RLC) packet distributed to entities of a plurality of HARQs of a media access control (MAC) layer.

The method may further include verifying whether results of the received plurality of feedbacks are identical.

The retransmitting may be performed when the results are not identical.

The method may further include retransmitting an HARQ with respect to the first packet using the first component carrier, when results of the plurality of feedbacks are identical.

The method may further include determining priorities between a first order of an upper layer of the first packet and a second order of a second packet to be transmitted using the second component carrier.

The retransmitting may be performed when the first order has a higher priority than the second order.

The method may further include retransmitting an HARQ with respect to the first packet using the first component carrier, when the first order does not have a higher priority than the second order.

The method may further include calculating a first gain for a case in which the first packet is transmitted using each of the plurality of component carriers. A second gain may correspond to a gain for a case in which the first packet is transmitted using the first component carrier. The retransmitting may be performed when a first gain greater than the second gain is present.

The method may further include retransmitting an HARQ with respect to the first packet using the first component carrier, when a first gain greater than the second gain is absent.

The first gain and the second gain may be obtained by applying the same modulation coding scheme (MCS) to the first component carrier and the second component carrier, respectively.

The first gain and the second gain may correspond to packet error rates.

The method may further include comparing a first gain for a case in which the first packet is transmitted using the second component carrier, to a second gain for a case in which the first packet is transmitted using the first component carrier.

The retransmitting may be performed when the first gain is greater than the second gain.

The method may further include verifying whether results of the received plurality of feedbacks are identical, determining priorities between a first order of an upper layer of the first packet and a second order of a second packet to be transmitted using the second component carrier, and calculating a first gain for a case in which the first packet is transmitted using each of the plurality of component carriers. A second gain may correspond to a gain for a case in which the first packet is transmitted using the first component carrier. The retransmitting may be performed when the results are not identical, when the first order has a higher priority than the second order, and when a first gain greater than the second gain is present.

The method may further include retransmitting an HARQ with respect to the first packet using the first component carrier, when the results are identical, when the first order does not have a higher priority than the second order, and when a first gain greater than the second gain is absent.

The retransmitting may include verifying whether the first packet is transmittable using a resource block (RB) assigned to the second component carrier.

The retransmitting may be performed when the first packet is transmittable using the RB assigned to the second component carrier.

The method may further include transmitting a third packet using the first component carrier.

A new data indicator (NDI) of the third packet may correspond to 2 bits, and the NDI may indicate whether the third packet corresponds to the first packet.

According to another aspect of the present invention, there is also provided a component carrier aggregation communication apparatus for transmitting a packet using a method of retransmitting an HARQ, the apparatus including a communication unit to transmit a plurality of packets using a plurality of component carriers, respectively, and to receive a plurality of feedbacks in response to the transmitting through the plurality of component carriers, and retransmit, using a second component carrier, a first packet transmitted using a first component carrier, among the plurality of packets, when a NACK feedback with respect to the first component carrier is received and an ACK feedback with respect to the second component carrier is received, among the plurality of component carriers.

The plurality of packets may correspond to an RLC packet distributed to entities of a plurality of HARQs of a MAC layer.

The apparatus may further include a processing unit to verify whether results of the received plurality of feedbacks are identical. The communication unit may perform the retransmitting when the results are not identical.

The apparatus may further include a processing unit to verify whether results of the received plurality of feedbacks are identical, determine priorities between a first order of an upper layer of the first packet and a second order of a second packet to be transmitted using the second component carrier, and calculate a first gain for a case in which the first packet is transmitted using each of the plurality of component carriers. A second gain may correspond to a gain for a case in which the first packet is transmitted using the first component carrier. The communication unit may perform the retransmitting when the results are not identical, when the first order has a higher priority than the second order, and when a first gain greater than the second gain is present.

### BRIEF DESCRIPTION OF THE DRAWINGS

These and/or other aspects, features, and advantages of the invention will become apparent and more readily appreciated from the following description of exemplary embodiments, taken in conjunction with the accompanying drawings of which:

FIG. 1 illustrates a hierarchical configuration of a system using component carrier aggregation technology according to an embodiment;

FIG. 2 illustrates a satellite communication system having a delay time according to an embodiment;

FIG. 3 illustrates a configuration of a component carrier aggregation communication apparatus according to an embodiment;

FIG. 4 is a flowchart illustrating a method of retransmitting a hybrid automatic repeat request (HARQ) in a component carrier aggregation communication apparatus according to an embodiment;

FIG. 5 is a flowchart illustrating a method of performing retransmission based on results of a plurality of feedbacks according to an embodiment;

FIG. 6 is a flowchart illustrating a method of performing retransmission based on an order of an upper layer of a packet according to an embodiment;

FIG. 7 is a flowchart illustrating a method of performing retransmission based on gains of component carriers according to an embodiment;

FIG. 8 is a flowchart illustrating a method of performing retransmission based on gains of component carriers according to another embodiment;

FIG. 9 is a flowchart illustrating a method of retransmitting an HARQ in a component carrier aggregation communication apparatus according to another embodiment; and

FIG. 10 is a flowchart illustrating a method of transmitting a third packet according to an embodiment.

### DETAILED DESCRIPTION

Reference will now be made in detail to exemplary embodiments of the present invention, examples of which are illustrated in the accompanying drawings, wherein like reference numerals refer to the like elements throughout. Exemplary embodiments are described below to explain the present invention by referring to the figures.

Though the present invention may be variously modified and have several embodiments, specific embodiments will be shown in drawings and be explained in detail. However, the present invention is not meant to be limited, but it is intended that various modifications, equivalents, and alternatives are also covered within the scope of the claims.

Terms used herein are to merely explain certain embodiments, not meant to limit the scope of the present invention. A singular expression includes a plural concept unless there is a contextually distinctive difference therebetween. In this description, the term “include” or “have” is intended to indicate that characteristics, numbers, steps, operations, components, elements, etc. disclosed in the specification or combinations thereof exist. As such, the term “include” or “have” should be understood that there are additional possibilities of one or more other characteristics, numbers, steps, operations, components, elements or combinations thereof.

Unless specifically defined, all the terms used herein including technical or scientific terms have the same meaning as terms generally understood by those skilled in the art. Terms defined in a general dictionary should be understood so as to have the same meanings as contextual meanings of the related art. Unless definitely defined in the present invention, the terms are not interpreted as ideal or excessively formal meanings.

Hereinafter, certain embodiments of the present invention will be explained in more detail with reference to the attached drawings. The same component or components corresponding to each other will be provided with the same reference numeral, and their detailed explanation will be omitted. When it is determined that a detailed description is related to a related known function or configuration which may make the purpose of the present disclosure unnecessarily ambiguous in the description, such a detailed description will be omitted.

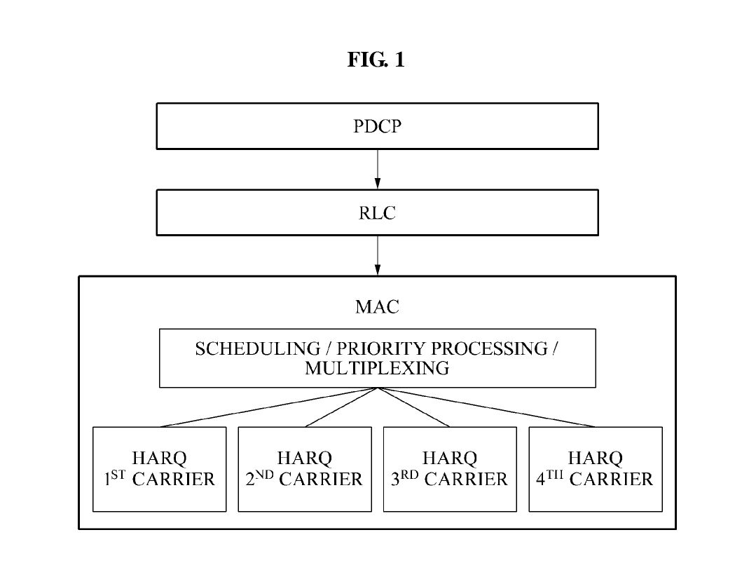

FIG. 1 illustrates a hierarchical configuration of a system using component carrier aggregation technology according to an embodiment.

Referring to FIG. 1, a packet data convergence protocol (PDCP) layer and a radio link control (RLC) layer of a third generation partnership project long term evolution Rel-8-advanced (3GPP LTE-A) system may correspond to a PDCP layer and an RLC layer of a long term evolution (LTD) system, respectively.

A medium access control (MAC) layer may transmit packets using a plurality of component carriers. A hybrid automatic repeat request (HARQ) entity for each component carrier may be present. Thus, the LTE-A system may support component carrier aggregation.

When the system supports component carrier aggregation, the MAC layer may manage the HARQ entity. By managing the HARQ entity, the MAC layer may perform packet transmission scheduling, priority processing, and multiplexing.

Thus, the PDCP layer and the RLC layer of the LTE-A system may perform the same operations as the PDCP layer and the RLC layer of the LTE system, irrespective of whether the system supports component carrier aggregation.

Table 1 shows an example of mapping packets of the RLC layer to HARQ entities of the MAC layer when the system supports component carrier aggregation.

TABLE 1

| | Packet of RLC layer | | | | | | | |
|---|---|---|---|---|---|---|---|---|
| | [1] | [2] | [3] | [4] | [5] | [6] | [7] | [8] |
| MAC layer/ | C1-[1] | C2-[1] | C1-[2] | C2-[2] | C1-[3] | C2-[3] | C1-[4] | C2-[4] |
| HARQ | | | | | | | | |

In this example, two component carriers C 1 and C2 may be aggregated. Packet of the RLC layer may be transmitted to be distributed to two HARQ entities of the MAC layer. The distributed packets may be transmitted using the component carriers C1 and C2.

A value of a packet of the RLC layer may indicate an order of the packet.

For example, a packet [4] of the RLC layer may correspond to a second packet transmitted by the component carrier C2 (C2-[2]).

Table 2 shows a case in which packets transmitted by the component carrier C1 are not transmitted due to increased interference with respect to the component carrier C1 in the example of Table 1.

TABLE 2

| | Packet of RLC layer | | | | | | | |
|---|---|---|---|---|---|---|---|---|
| | [1] | [2] | [3] | [4] | [5] | [6] | [7] | [8] |
| MAC layer/ | C1-[1] | C2-[1] | C1-[2] | C2-[2] | C1-[3] | C2-[3] | C1-[4] | C2-[4] |
| HARQ | | | | | | | | |
| Feedback | NACK | ACK | NACK | ACK | NACK | ACK | NACK | ACK |

A feedback may refer to a response to packet transmission. When the packet transmission is performed successfully, an acknowledgement (ACK) feedback may be received. Conversely, when the packet transmission is not performed successfully, a negative acknowledgement (NACK) feedback may be received.

Referring to Table 2, the component carrier C1 may receive NACK feedbacks with respect to the packets [1], [3], [5], and [7] of the RLC layer. When a NACK feedback is received, retransmission of a corresponding packet may be necessary.

The RLC layer may receive packets until all packets are received in order, and perform packet reordering. The RLC layer may perform packet reordering to arrange the packets in order. The RLC layer may transfer the arranged packets to the PDCP layer.

Thus, a data transmission delay time may occur when the packets [1], [3], [5], and [7] transmitted using the component carrier C1 are not transmitted to the RLC layer.

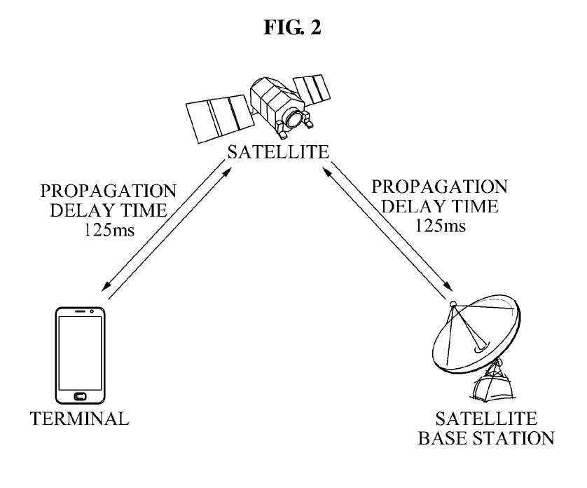

FIG. 2 illustrates a satellite communication system having a delay time according to an embodiment.

The delay time described with reference to Table 2 may occur during communication between a terminal and a satellite. The delay time may also occur during communication between a satellite and a satellite base station.

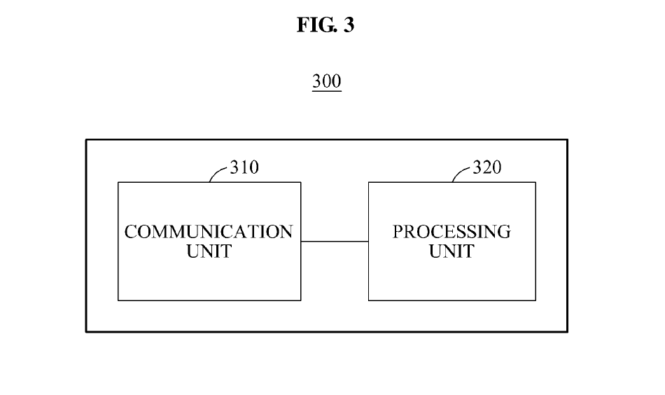

To resolve such issues on a delay time, methods of retransmitting an HARQ will be described in detail with reference to FIGS. 3 through 10.

FIG. 3 illustrates a configuration of a component carrier aggregation communication apparatus 300 according to an embodiment.

Referring to FIG. 3, the component carrier aggregation communication apparatus 300, hereinafter, simply referred to as the apparatus 300, may include a communication unit 310 and a processing unit 320.

The processing unit 320 may include a processor.

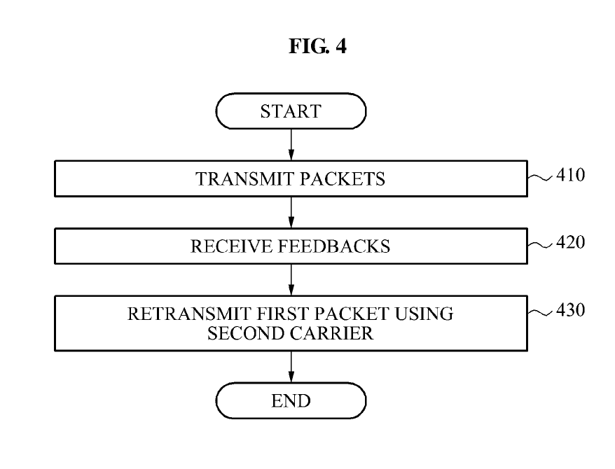

The communication unit 310 and the processing unit 320 will be described in detail with reference to FIGS. 4 through 10.

FIG. 4 is a flowchart illustrating a method of retransmitting an HARQ in the apparatus 300 according to an embodiment.

Hereinafter, a method of retransmitting, using a component carrier less affected by interference, a packet transmitted using a component carrier more affected by interference will be described in detail.

In operation 410, the communication unit 310 may transmit a plurality of packets using a plurality of component carriers. The plurality of component carriers may be used to transmit the plurality of packets, respectively.

The plurality of packets may correspond to an RLC packet distributed to entities of a plurality of HARQs of a MAC layer.

In operation 420, the communication unit 310 may receive a plurality of feedbacks in response to the transmitting through the plurality of component carriers. A feedback may indicate a result of packet transmission.

The feedback may include an ACK feedback indicating successful packet transmission, and a NACK feedback indicating failed packet transmission.

For example, when the communication unit 310 receives a NACK feedback through a first component carrier, the NACK feedback may indicate failure of packet transmission using the first component carrier.

In operation 430, the communication unit 310 may retransmit, using a second component carrier, the first packet transmitted using the first component carrier, among the plurality of packets. In this example, the second component carrier may correspond to a component carrier through which an ACK feedback is received.

Each of the first component carrier and the second component carrier may correspond to one of the plurality of component carriers.

In operation 430, the communication unit 310 may verify whether the first packet is transmittable using a resource block (RB) assigned to the second component carrier.

The communication unit 310 may perform the retransmitting when the first packet is transmittable using the RB assigned to the second component carrier.

For example, when three RBs are assigned to the second component carrier, the first packet may be retransmitted within a range of three blocks.

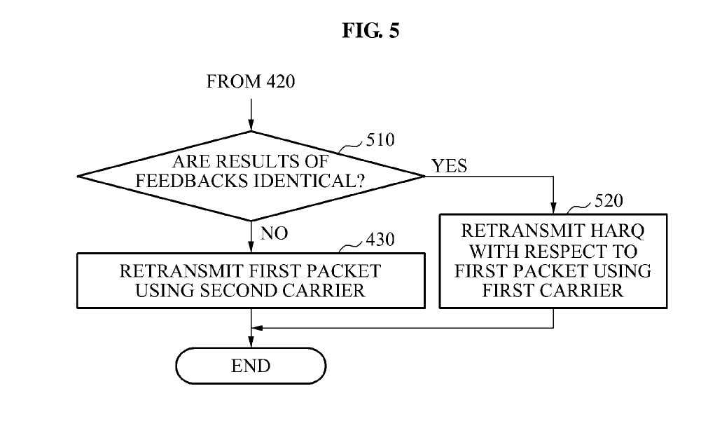

FIG. 5 is a flowchart illustrating a method of performing retransmission based on results of a plurality of feedbacks according to an embodiment.

Operation 510 may be performed after operation 420.

In operation 510, the processing unit 320 may verify whether results of the received plurality of feedbacks are identical.

For example, the results of the plurality of feedbacks may identically correspond to ACK feedbacks. When the results of the plurality of feedbacks identically correspond to ACK feedbacks, operation 410 may be performed.

As another example, the results of the plurality of feedbacks may identically correspond to NACK feedbacks. When the results of the plurality of feedbacks identically correspond to NACK feedbacks, operation 520 may be performed.

As still another example, the results of the plurality of feedbacks may differ. When the results of the plurality of feedbacks are not identical, operation 430 may be performed.

In operation 520, the communication unit 310 may retransmit an HARQ with respect to the first packet using the first component carrier. The first component carrier may correspond to a component carrier through which a NACK feedback with respect to transmission of the first packet is received.

The communication unit 310 may retransmit the first packet using the first component carrier.

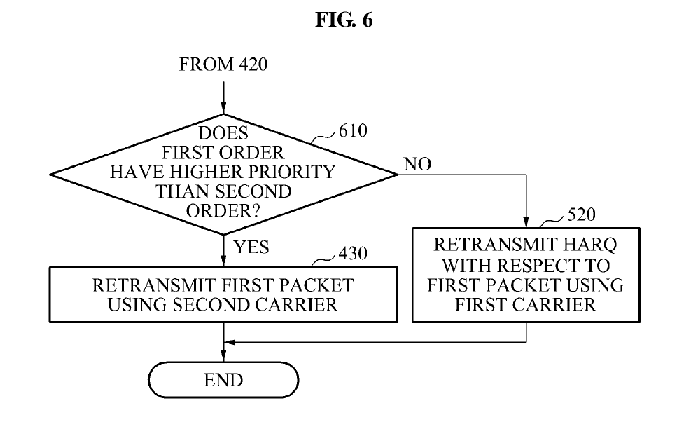

FIG. 6 is a flowchart illustrating a method of performing retransmission based on an order of an upper layer of a packet according to an embodiment.

Operation 610 may be performed after operation 420.

In operation 610, the processing unit 320 may determine priorities between a first order of an upper layer of a first packet and a second order of a second packet to be transmitted using the second component carrier.

The first packet may correspond to a packet for which transmission using the first component carrier fails.

The second packet may correspond to one of the plurality of packets.

The upper layer may correspond to an RLC layer

For example, when the first packet corresponds to the packet [1] of the RLC layer having a primary order in Table 2, the second packet may correspond to the packet [2] of the RLC layer having a quaternary order.

In this example, the processing unit 320 may determine that the first order of the upper layer of the first packet has a higher priority than the second order of the second packet.

When the first order has a higher priority than the second order, operation 430 may be performed.

In operation 430, the second component carrier may correspond to a component carrier to be used to transmit a packet having a lowest order of the upper layer.

For example, five component carriers and ten packets may be provided. When packets excluding a packet having a primary order of the upper layer, for example, packets having secondary to quinary orders, are transmitted in operation 410, the second component carrier in operation 430 may correspond to a component carrier to be used to transmit a packet having a denary order. The second component carrier may have been used to transmit a packet of the quinary packet.

When the first order does not have a higher priority than the second order, operation 520 may be performed.

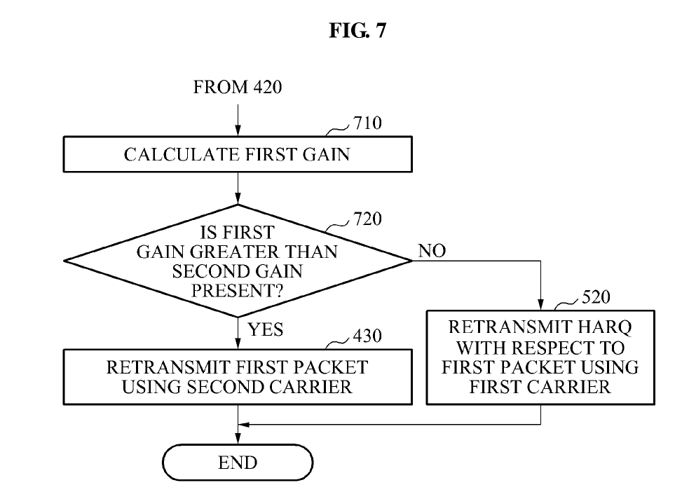

FIG. 7 is a flowchart illustrating a method of performing retransmission based on gains of component carriers according to an embodiment.

Operation 710 may be performed after operation 420.

In operation 710, the processing unit 320 may calculate a first gain for a case in which the first packet is transmitted using each of the plurality of component carriers. The first packet may correspond to a packet for which transmission using the first component carrier fails.

The processing unit 320 may calculate a second gain for a case in which the first packet is transmitted using the first component carrier.

The processing unit 320 may calculate the first gain and the second gain by applying the same modulation coding scheme (MCS) to the first component carrier and the second component carrier, respectively.

The first gain and the second gain may correspond to packet error rates.

In operation 720, the processing unit 320 may verify whether a first gain greater than the second gain is present.

When a first gain greater than the second gain is present, operation 430 may be performed.

In operation 430, the second component carrier may correspond to a component carrier with a greatest first gain among a plurality of first gains.

When a first gain greater than the second gain is absent, operation 520 may be performed.

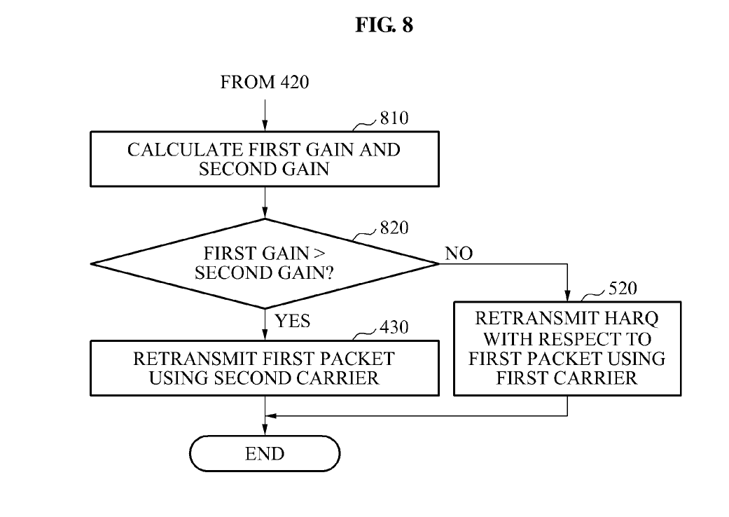

FIG. 8 is a flowchart illustrating a method of performing retransmission based on gains of component carriers according to another embodiment.

Operation 810 may be performed after operation 420.

In operation 810, the processing unit 320 may calculate a first gain for a case in which the first packet is transmitted using the second component carrier, and a second gain for a case in which the first packet is transmitted using the first component carrier. The first packet may correspond to a packet failed to be transmitted using the first component carrier.

In operation 820, the processing unit 320 may compare the first gain to the second gain.

When the first gain is greater than the second gain, operation 430 may be performed.

Conversely, when the first gain is not greater than the second gain, operation 520 may be performed.

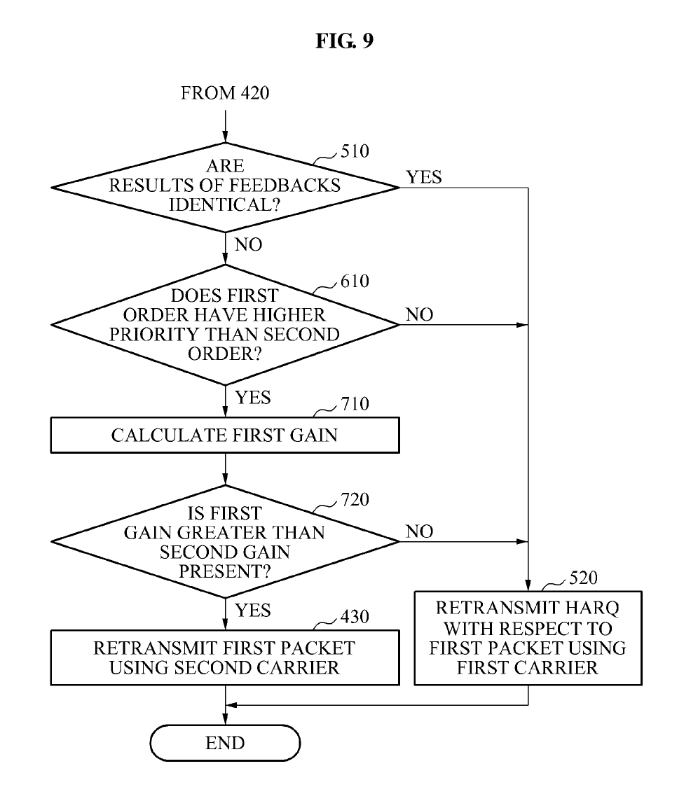

FIG. 9 is a flowchart illustrating a method of retransmitting an HARQ in a component carrier aggregation communication apparatus according to another embodiment.

Operation 510 may be performed after operation 420.

In operation 510, the processing unit 320 may verify whether results of the received plurality of feedbacks are identical.

When the results of the plurality of feedbacks are not identical, operation 610 may be performed.

Conversely, when the results of the plurality of feedbacks are identical, operation 520 may be performed.

In operation 610, the processing unit 320 may determine priorities between a first order of an upper layer of a first packet and a second order of a second packet to be transmitted using the second component carrier.

The first packet may correspond to a packet failed to be transmitted using the first component carrier.

The second component carrier may correspond to a component carrier through which an ACK feedback is received in operation 420.

Operation 610 may be re-performed. During the re-performance of operation 610, the processing unit 320 may replace the second component carrier with another component carrier among the plurality of component carriers. The processing unit 320 may re-perform operation 610 by replacing the second component carrier with another component carrier of the plurality of component carriers.

When all orders of packets to be transmitted using a plurality of component carriers excluding the first component carrier have higher priorities than the first order of the first packet, operation 520 may be performed.

When the first order has a higher priority than the second order, operation 710 may be performed.

In operation 710, the processing unit 320 may calculate a first gain for a case in which the first packet is transmitted using each of the plurality of component carriers. Each of the plurality of component carriers may correspond to a component carrier to be used to transmit packets having lower priorities than the first order of the upper layer of the first packet.

The processing unit 320 may calculate a second gain for a case in which the first packet is transmitted using the first component carrier.

In operation 720, the processing unit 320 may verify whether a first gain greater than the second gain is present.

When a first gain greater than the second gain is absent, operation 520 may be performed.

Conversely, when a first gain greater than the second gain is present, operation 430 may be performed.

In operation 430, the communication unit 310 may retransmit the first packet using the second component carrier.

Operation 430 may be performed when the results of the plurality of feedbacks are not identical, when the first order has a higher priority than the second order, and when a first gain greater than the second gain is present.

In operation 430, the second component carrier may correspond to a component carrier through which an ACK feedback is received, a component carrier to be used to transmit a packet having the second order having a lower priority than the first order, and a component carrier having a first gain greater than the second gain. That is, the second component carrier may correspond to a component carrier satisfying all three of the foregoing conditions among the plurality of component carriers. In addition, the second component carrier may correspond to a component carrier that satisfies the foregoing conditions, among remaining component carriers, excluding the first component carrier from the plurality of component carriers.

In operation 520, the communication unit 310 may retransmit an HARQ with respect to the first packet using the first component carrier.

Operation 520 may be performed in at least one of a case in which the results of the plurality of feedbacks are identical, a case in which the first order does not have a higher priority than the second order, and a case in which a first gain greater than the second gain is absent.

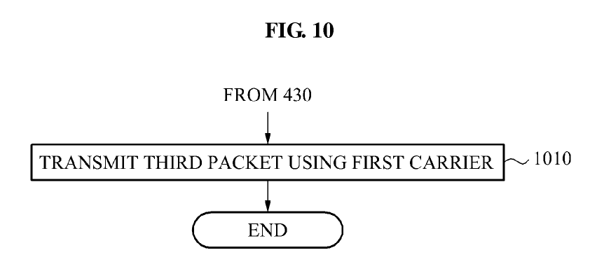

FIG. 10 is a flowchart illustrating a method of transmitting a third packet according to an embodiment.

Operation 1010 may be performed after operation 430.

In operation 1010, the communication unit 310 may transmit a third packet using the first component carrier. The third packet may correspond to one of the plurality of packets.

The third packet may include a new data indicator (NDI). The NDI may indicate whether the third packet corresponds to the first packet.

The NDI may correspond to 2 bits.

Table 3 lists information indicated by the NDI.

TABLE 3

| Value | Information |
|---|---|
| 00 | New packet |
| 01 | Retransmitted packet |
| 10 | New packet transmitted using changed component carrier |
| 11 | Reserved |

A value “00” of the NDI may indicate that a packet corresponds to a new packet.

A value “01” of the NDI may indicate that a packet corresponds to a retransmitted packet.

A value “10” of the NDI may indicate that a packet corresponds to a new packet transmitted using a replaced component carrier.

In operation 1010, when the communication unit 310 transmits the third packet using the first component carrier, the value of the NDI of the third packet may correspond to “10”.

When the value of the third packet corresponds to “10”, an HARQ entity may delete the first packet stored in a buffer of a receiver, and perform an operation with respect to the third packet.

The first packet and the second packet may also include NDIs.

The descriptions provided with reference to FIGS. 1 through 9 may be applied hereto and thus, duplicated descriptions will be omitted for conciseness.

According to an embodiment, an apparatus and method may transmit a packet.

According to an embodiment, an apparatus and method may retransmit an HARQ.

The methods according to the above-described exemplary embodiments of the present invention may be recorded in computer-readable media including program instructions to implement various operations embodied by a computer. The media may also include, alone or in combination with the program instructions, data files, data structures, and the like. Examples of computer-readable media include magnetic media such as hard disks, floppy disks, and magnetic tape; optical media such as CD ROM discs and DVDs; magneto-optical media such as floptical discs; and hardware devices that are specially configured to store and perform program instructions, such as read-only memory (ROM), random access memory (RAM), flash memory, and the like. Examples of program instructions include both machine code, such as produced by a compiler, and files containing higher level code that may be executed by the computer using an interpreter. The described hardware devices may be configured to act as one or more software modules in order to perform the operations of the above-described exemplary embodiments of the present invention, or vice versa.

A number of examples have been described above. Nevertheless, it should be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. A method of retransmitting a hybrid automatic repeat request (HARQ) in a component carrier aggregation communication apparatus for transmitting a packet, the method comprising:
transmitting a plurality of packets using a plurality of component carriers, respectively;
receiving a plurality of feedbacks in response to the transmitting through the plurality of component carriers; and
retransmitting, using a second component carrier, a first packet transmitted using a first component carrier, among the plurality of packets, when a negative acknowledgement (NACK) feedback with respect to the first component carrier is received and an acknowledgment (ACK) feedback with respect to the second component carrier is received, among the plurality of component carriers.

2. The method of claim 1, wherein the plurality of packets corresponds to a radio link control (RLC) packet distributed to entities of a plurality of HARQs of a media access control (MAC) layer.

3. The method of claim 2, further comprising:
verifying whether results of the received plurality of feedbacks are identical,
wherein the retransmitting is performed when the results are not identical.

4. The method of claim 2, further comprising:
retransmitting an HARQ with respect to the first packet using the first component carrier, when results of the plurality of feedbacks are identical.

5. The method of claim 1, further comprising:
determining priorities between a first order of an upper layer of the first packet and a second order of a second packet to be transmitted using the second component carrier,
wherein the retransmitting is performed when the first order has a higher priority than the second order.

6. The method of claim 5, further comprising:
retransmitting an HARQ with respect to the first packet using the first component carrier, when the first order does not have a higher priority than the second order.

7. The method of claim 1, further comprising:
calculating a first gain for a case in which the first packet is transmitted using each of the plurality of component carriers,
wherein a second gain corresponds to a gain for a case in which the first packet is transmitted using the first component carrier, and
the retransmitting is performed when a first gain greater than the second gain is present.

8. The method of claim 7, further comprising:
retransmitting an HARQ with respect to the first packet using the first component carrier, when a first gain greater than the second gain is absent.

9. The method of claim 7, wherein the first gain and the second gain are obtained by applying the same modulation coding scheme (MCS) to the first component carrier and the second component carrier, respectively.

10. The method of claim 7, wherein the first gain and the second gain correspond to packet error rates.

11. The method of claim 1, further comprising:
comparing a first gain for a case in which the first packet is transmitted using the second component carrier, to a second gain for a case in which the first packet is transmitted using the first component carrier,
wherein the retransmitting is performed when the first gain is greater than the second gain.

12. The method of claim 1, further comprising:
verifying whether results of the received plurality of feedbacks are identical;
determining priorities between a first order of an upper layer of the first packet and a second order of a second packet to be transmitted using the second component carrier; and
calculating a first gain for a case in which the first packet is transmitted using each of the plurality of component carriers,
wherein a second gain corresponds to a gain for a case in which the first packet is transmitted using the first component carrier, and
the retransmitting is performed when the results are not identical, when the first order has a higher priority than the second order, and when a first gain greater than the second gain is present.

13. The method of claim 12, further comprising:
retransmitting an HARQ with respect to the first packet using the first component carrier, when the results are identical, when the first order does not have a higher priority than the second order, and when a first gain greater than the second gain is absent.

14. The method of claim 1, wherein the retransmitting comprises verifying whether the first packet is transmittable using a resource block (RB) assigned to the second component carrier,
wherein the retransmitting is performed when the first packet is transmittable using the RB assigned to the second component carrier.

15. The method of claim 1, further comprising:
transmitting a third packet using the first component carrier.

16. The method of claim 15, wherein a new data indicator (NDI) of the third packet corresponds to 2 bits, and
the NDI indicates whether the third packet corresponds to the first packet.

17. A component carrier aggregation communication apparatus for transmitting a packet using a method of retransmitting a hybrid automatic repeat request (HARQ), the apparatus comprising:
a communication unit to transmit a plurality of packets using a plurality of component carriers, respectively, and to receive a plurality of feedbacks in response to the transmitting through the plurality of component carriers, and retransmit, using a second component carrier, a first packet transmitted using a first component carrier, among the plurality of packets, when a negative acknowledgement (NACK) feedback with respect to the first component carrier is received and an acknowledgment (ACK) feedback with respect to the second component carrier is received, among the plurality of component carriers.

18. The apparatus of claim 17, wherein the plurality of packets corresponds to a radio link control (RLC) packet distributed to entities of a plurality of HARQs of a media access control (MAC) layer.

19. The apparatus of claim 18, further comprising:
a processing unit to verify whether results of the received plurality of feedbacks are identical,
wherein the communication unit performs the retransmitting when the results are not identical.

20. The apparatus of claim 17, further comprising:
a processing unit to verify whether results of the received plurality of feedbacks are identical, determine priorities between a first order of an upper layer of the first packet and a second order of a second packet to be transmitted using the second component carrier, and calculate a first gain for a case in which the first packet is transmitted using each of the plurality of component carriers,
wherein a second gain corresponds to a gain for a case in which the first packet is transmitted using the first component carrier, and
the communication unit performs the retransmitting when the results are not identical, when the first order has a higher priority than the second order, and when a first gain greater than the second gain is present.
